(19) United States
(12) Patent Application Publication
(10) Pub. No.: US 2021/0089621 A1
(43) Pub. Date: Mar. 25, 2021

(54) SECONDARY LANGUAGE SUPPORT

(71) Applicant: LENOVO ENTERPRISE SOLUTIONS (SINGAPORE) PTE. LTD., SINGAPORE (SG)

(72) Inventors: MARK E. MOLANDER, CARY, NC (US); CHEKIM CHHUOR, SHANGHAI (CN)

(21) Appl. No.: 16/601,955

(22) Filed: Oct. 15, 2019

(30) Foreign Application Priority Data
Sep. 20, 2019 (CN) 201910892924.X

(51) Int. Cl. G06F 17/27; G06F 3/0481

(52) U.S. Cl. CPC G06F 17/2765; G06F 17/275; G06F 3/0481

(57) ABSTRACT

Secondary language support may include determining a primary language and a secondary language associated with a user; generating a first portion of content data based on the primary language; generating a second portion of the content data based on the secondary language; and sending, to a user device associated with the user, the first portion of the content data and the second portion of the content data.

### CROSS-REFERENCE TO RELATED APPLICATION

This application claims priority under 35 U.S.C § 119 to Chinese patent application no. 201910892924.X, filed Sep. 20, 2019, the entire text of which is specifically incorporated by reference herein.

### BACKGROUND

### Field of the Invention

The field of the invention is data processing, or, more specifically, methods, apparatus, and products for secondary language support.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

User devices may access content data (e.g., web pages) based on a primary language. For example, a browser application may have a primary language setting as part of a user profile or configuration. As another example, a search engine or other website may provide content in a language based on a top-level domain used to access the website. Providing content data in the primary language may include translating source data from one language to the primary language. This approach may result in translation errors, making comprehension of the content data difficult. Moreover, this approach does not address users who may be proficient in more than one language.

### SUMMARY

Secondary language support may comprise determining a primary language and a secondary language associated with a user; generating a first portion of content data based on the primary language; generating a second portion of the content data based on the secondary language; and sending, to a user device associated with the user, the first portion of the content data and the second portion of the content data.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram of an example system for secondary language support.

FIG. 2 is a block diagram of a computer configured for secondary language support.

FIG. 3 is an example user interface for secondary language support.

FIG. 4 is an example user interface for secondary language support.

FIG. 5 is an example user interface for secondary language support.

FIG. 6 is an example user interface for secondary language support.

FIG. 7 is a flowchart of an example method for secondary language support.

FIG. 8 is a flowchart of an example method for secondary language support.

FIG. 9 is a flowchart of an example method for secondary language support.

### DETAILED DESCRIPTION

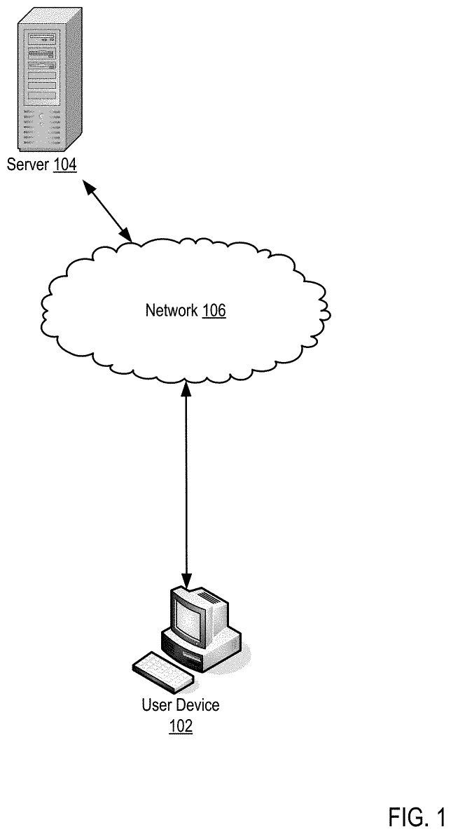

Exemplary methods, apparatus, and products for secondary language support in accordance with the present invention are described with reference to the accompanying drawings, beginning with FIG. 1. FIG. 1 sets forth a network diagram of a system configured for secondary language support according to embodiments of the present invention. The system of FIG. 1 includes a user device 102 and server 104 which are in communication via a network 106. The user device 102 may comprise a laptop computer, desktop computer, mobile device (e.g., smartphone or tablet), or other computing device as can be appreciated. The server 104 may comprise one or more servers 104 configured to provide content and/or services (e.g., web sites, web content, web applications) to the user device 102. The network 106 may comprise one or more Local Area Networks (LANs), Wide Area Networks (WANs), cellular networks, personal area networks, wired or wireless networks, or combinations thereof.

The server 104 may be configured to provide content data (e.g., a web site) the user device 102. To do so, the server 104 may determine a primary language and secondary language associated with a user (e.g., the user device 102). Determining the primary language and secondary language may comprise receiving an indication of a browser setting, application setting, profile setting, or configuration setting associated with the user device 102 indicating the primary language and secondary language. Determining the primary language and secondary language may comprise accessing a setting, preference, or other configuration option associated with a session or user account associated with the user device 102. Determining the primary language or secondary language may be based on a top-level domain used to access the server 104. For example, the primary language or secondary language may be determined as a language corresponding to a particular top-level domain (e.g., English for .uk, Spanish for .es, Japanese for .jp). The primary language or secondary language not determined according to the top-level domain may then be determined by another approach (e.g., a browser setting, a user account setting, etc.).

The server 104 may then generate a first portion of content data based on the primary language. Generating the first portion of content data based on the primary language may comprise translating source content data to the primary language. A translation algorithm may be applied to a web page or other source content data to translate the text of the source content data into the primary language. For example, assuming a primary language setting of English, the text of a web page encoded in Spanish may be translated into English. Accordingly, generating the first portion of the content data may comprise replacing portions of the source content data (e.g., the untranslated text) with corresponding portions translated into the primary language. Generating the first portion of the content data may also comprise accessing a language file or version of the source content data encoded in the primary language and encoding a portion of the accessed version as the first portion of the content data. The language file or version of the source content data may comprise a user generated or manually crafted translation of the source content data into the primary language.

Generating the first portion of the content data based on the primary language may comprise generating a first portion of search results based on the primary language and a search query. For example, a search engine may limit a scope of search to data (e.g., web sites) written in or encoded in a particular language. Accordingly, generating the first portion of the content data based on the primary language may comprise generating the first portion of search results responsive to the search query based on a scope defined by the primary language. As another example, a search engine may perform natural language processing on the search query or searchable data based on the primary language.

Next, the server 104 may generate a second portion of the content data based on the secondary language. For example, where the first portion of the content data is generated by translating source content data into the primary language or accessing a language file of the source content data associated with the primary language, generating the second portion of the content data may comprise selecting one or more keywords (e.g., of text in the source content data) and encoding, as the second portion of the content data, the one or more keywords in the secondary language.

For example, selecting the one or more keywords may comprise selecting one or more identified keywords. The one or more keywords may be selected based on a tag, identifier, or other encoding in the source content data (e.g., a markup language tag). The one or more keywords may also be selected based on a template element that includes the one or more keywords. For example, the one or more keywords may be selected as keywords included in a header or menu.

Selecting the one or more keywords may also comprise selecting the one or more keywords based on a translation exception. The translation exception may be associated with the translation of the source content data to the primary language. A translation exception may include a particular keyword not being included in a dictionary or other listing of words in the primary language. The translation algorithm may programmatically or dynamically translate the particular keyword for inclusion in the first portion of the content data (e.g., using natural language processing). Such a keyword may be considered a potentially incorrect translation as no exact listing for the keyword may be found.

The selected one or more keywords may then be encoded, as the second portion of the content data, in the secondary language. Encoding the selected one or more keywords in the secondary language may comprise translating the one or more keywords into the secondary language. Encoding the selected one or more keywords may also comprise accessing a version of the source content data encoded in the secondary language (e.g., a different language file for the source data). The language file or version of the source content data may comprise a user generated or manually crafted translation of the source content data into the secondary language. The source content data may be encoded in the secondary language. Accordingly, generating the second portion of the content data may comprise encoding the one or more keywords in the content data untranslated (e.g., in the secondary language).

Generating the second portion of the content data based on the secondary language may comprise encoded the second portion of the content data as a hidden portion of the content data. A hidden portion of the content data may comprise a portion of the content data that is not rendered (e.g., by a browser) on initial loading or rendering. A hidden portion of the content data may comprise a portion of the content data that is not rendered unless a user interaction is directed to the content data. In other words, the hidden portion of the content data is configured to be rendered in response to the user interaction with the content data.

For example, the second portion of the content data may be encoded to be rendered in response to a selection, a hover event, a click event, or other interaction with the content data. As an example, where the second portion of the content data corresponds to one or more identified keywords, the second portion of the content data (e.g., the one or more identified keywords encoded in the secondary language) may be rendered in response to a user interaction with the one or more identified keywords in the content data as encoded in the primary language.

Where generating the first portion of the content data based on the primary language comprises generating a first portion of search results based on the primary language and a search query, generating the second portion of the content data based on the second language may comprise generating a second portion of search results based on the secondary language and the search query. Thus, the content data comprises a first portion of search results based on the primary language and a second portion of search results based on the secondary language.

The server 104 may then send, to the user device, the first portion of the content data and the second portion of the content data. For example, the server 104 may send the content data (e.g., comprising the first portion of the content data and the second portion of the content data) as a web page or other content. The content data may comprise, for example, a web page comprising the text data of the source content data translated into the primary language (e.g., the first portion of the content data) and one or more keywords encoded and/or translated to the second language (e.g., the second portion of the content data). The content data may also comprise search results responsive to a search query, with a first portion of the search results being based on the primary language (e.g., the first portion of the content data) and a second portion of the search results based on the secondary language (e.g., the second portion of the content data).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

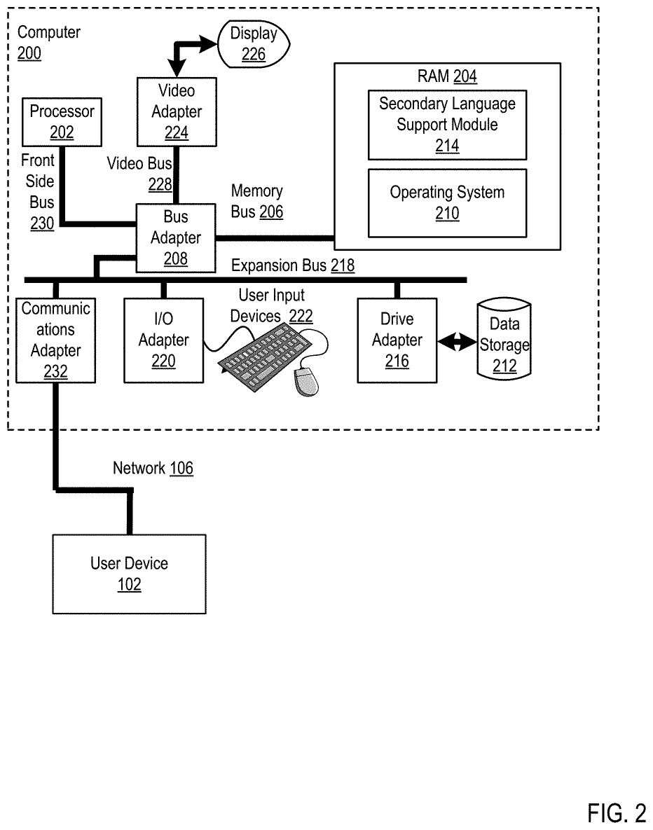

Enhanced usability for product enhancement submissions in accordance with the present invention is generally implemented with computers, that is, with automated computing machinery. For further explanation, therefore, FIG. 2 sets forth a block diagram of automated computing machinery comprising an exemplary computer 200 configured for enhanced usability for product enhancement submissions according to embodiments of the present invention. The computer 200 of FIG. 2 includes at least one computer processor 202 or ‘CPU’ as well as random access memory 204 (RAM′) which is connected through a high speed memory bus 206 and bus adapter 208 to processor 202 and to other components of the computer 200.

Stored in RAM 204 is an operating system 210. Operating systems useful in computers configured for enhanced usability for product enhancement submissions according to embodiments of the present invention include UNIX™, Linux™, Microsoft Windows™, AIX™ IBM's i OS™, and others as will occur to those of skill in the art. The operating system 208 in the example of FIG. 2 is shown in RAM 204, but many components of such software typically are stored in non-volatile memory also, such as, for example, on data storage 212, such as a disk drive. Also stored in RAM is the secondary language support module 214, a module for secondary language support according to embodiments of the present invention.

The computer 200 of FIG. 2 includes disk drive adapter 216 coupled through expansion bus 218 and bus adapter 208 to processor 202 and other components of the Computer 200. Disk drive adapter 216 connects non-volatile data storage to the computer 200 in the form of data storage 212. Disk drive adapters useful in computers configured for enhanced usability for product enhancement submissions according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer 200 of FIG. 2 includes one or more input/output (′I/O′) adapters 220. I/O adapters implement user-oriented input/output through, for example, software drivers and computer hardware for controlling output to display devices such as computer display screens, as well as user input from user input devices 222 such as keyboards and mice. The example Computer 200 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary computer 200 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for enhanced usability for product enhancement submissions according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes one or more user devices 102.

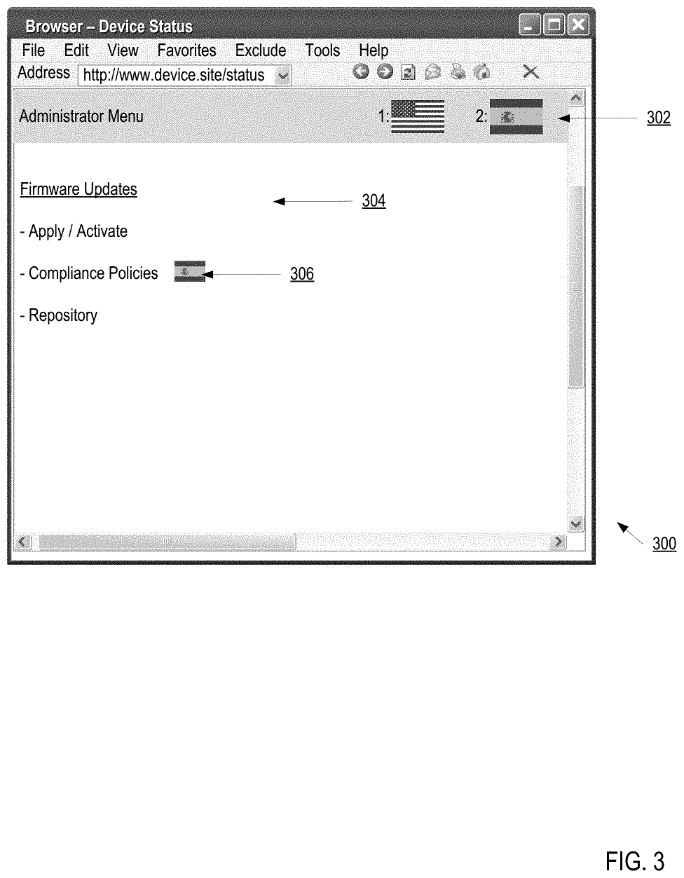

FIG. 3 shows an example user interface 300 for secondary language support according to embodiments of the present invention. The user interface 300 includes a language setting 302 displaying a primary language and secondary language (e.g., as determined by a server 104). In this example, the primary language is determined to be English, shown by the flag of the United States of America, while the secondary language is determined to be Spanish, shown by the flag of Spain. Also included in the user interface 300 is a content pane 304 displaying text data. For example, the text data may correspond to a first portion of content data (e.g., sent by a server 104 to a user device 102) encoded in the primary language of English. Within the content pane 304 is an icon 306 indicating the secondary language. The icon 306 corresponds to the keyword “Compliance Policies.”

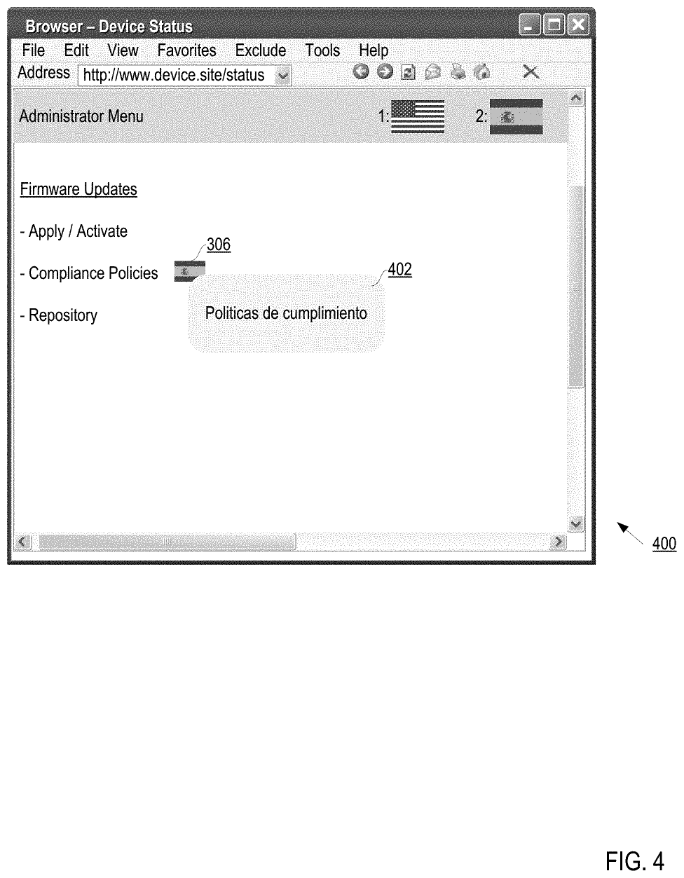

FIG. 4 shows an example user interface 400 for secondary language support according to embodiments of the present invention. The user interface 400 differs from the user interface 300 of FIG. 3 in that the user interface 400 includes a pop-up menu 402. The pop-up menu 402 may be rendered in response to a user interaction with the icon 306, e.g., a selection, a hover event, etc. The pop-up menu 402 includes the secondary language (e.g., Spanish) translation of the identified keyword “Compliance Policies.” In other words, the pop-up menu 402 is configured to display the second portion of the content data encoded in the secondary language of Spanish in response to the user interaction with the icon 306. Thus, the second portion of the content data is hidden until the user interaction is performed.

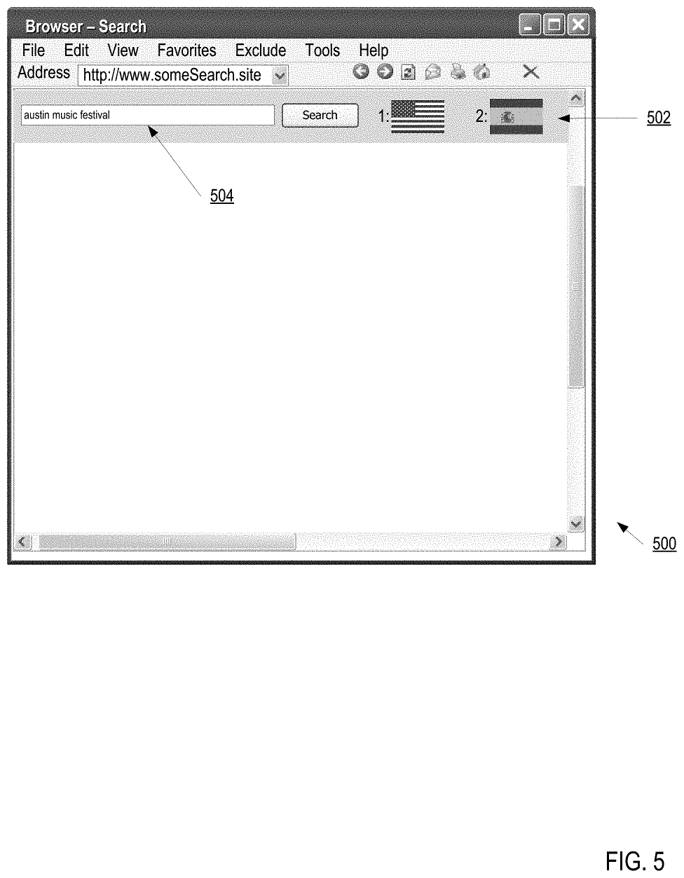

FIG. 5 shows an example user interface 500 for secondary language support according to embodiments of the present invention. The user interface 500 includes a language setting 502 displaying a primary language and secondary language (e.g., as determined by a server 104). In this example, the primary language is determined to be English, shown by the flag of the United States of America, while the secondary language is determined to be Spanish, shown by the flag of Spain. Also included in the user interface 500 is a text input field 504 facilitating the input of a search query.

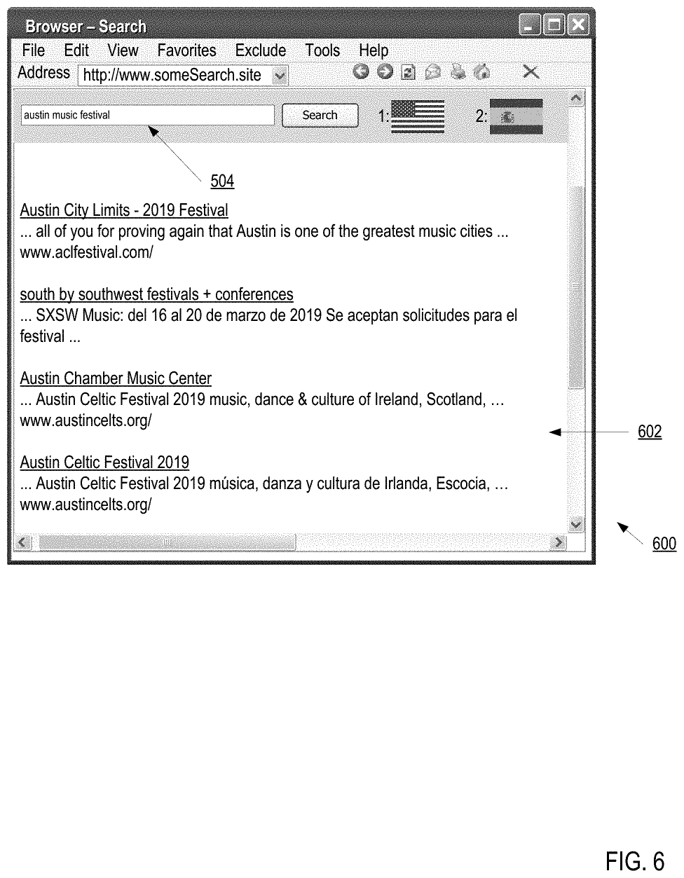

FIG. 6 shows an example user interface 600 for secondary language support according to embodiments of the present invention. The user interface 600 differs from the user interface 500 of FIG. 5 in that the user interface 600 includes a content pane 602 displaying search results (e.g., content data) in both the primary language of English (e.g., the first portion of the content data) and in the secondary language of Spanish (e.g., the second portion of the content data).

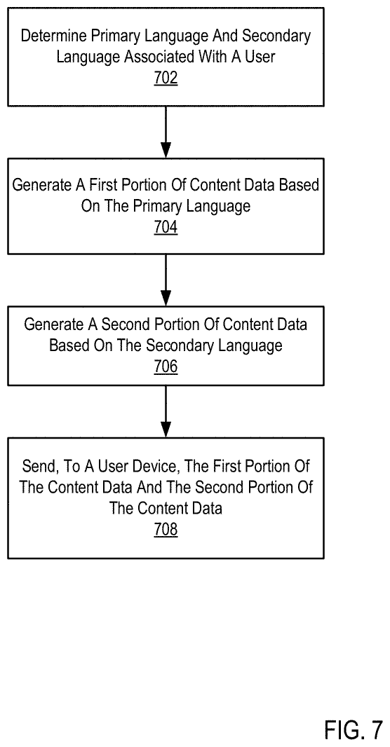

For further explanation, FIG. 7 sets forth a flow chart illustrating an exemplary method for secondary language support according to embodiments of the present invention that includes determining 702 (e.g., by a server 104) a primary language and secondary language associated with a user (e.g., the user device 102). Determining the primary language and secondary language may comprise receiving an indication of a browser setting, application setting, profile setting, or configuration setting associated with the user device 102 indicating the primary language and secondary language. Determining the primary language and secondary language may comprise accessing a setting, preference, or other configuration option associated with a session or user account associated with the user device 102. Determining the primary language or secondary language may be based on a top-level domain used to access the server 104. For example, the primary language or secondary language may be determined as a language corresponding to a particular top-level domain (e.g., English for .uk, Spanish for .es, Japanese for .jp). The primary language or secondary language not determined according to the top-level domain may then be determined by another approach (e.g., a browser setting, a user account setting, etc.).

The method of FIG. 7 may further comprise generating 704 (e.g., by the server 104) a first portion of content data based on the primary language. Generating the first portion of content data based on the primary language may comprise translating source content data to the primary language. Generating the first portion of the content data based on the primary language may comprise generating a first portion of search results based on the primary language and a search query. Generating the first portion of the content data may also comprise accessing a language file or version of the source data encoded in the primary language and encoding a portion of the accessed version as the first portion of the content data. The language file or version of the source content data may comprise a user generated or manually crafted translation of the source content data into the primary language.

The method of FIG. 7 may further comprise generating 706 (e.g., by the server 104) a second portion of the content data based on the secondary language. For example, where the first portion of the content data is generated by translating source content data into the primary language, generating the second portion of the content data may comprise selecting one or more keywords (e.g., of text in the source content data) and encoding, as the second portion of the content data, the one or more keywords in the secondary language. Where generating the first portion of the content data based on the primary language comprises generating a first portion of search results based on the primary language and a search query, generating the second portion of the content data based on the second language may comprise generating a second portion of search results based on the secondary language and the search query. Thus, the content data comprises a first portion of search results based on the primary language and a second portion of search results based on the secondary language.

Generating the second portion of the content data based on the secondary language may comprise encoded the second portion of the content data as a hidden portion of the content data. A hidden portion of the content data may comprise a portion of the content data that is not rendered (e.g., by a browser) on initial loading or rendering. A hidden portion of the content data may comprise a portion of the content data that is not rendered unless a user interaction is directed to the content data. In other words, the hidden portion of the content data is configured to be rendered in response to the user interaction with the content data.

For example, the second portion of the content data may be encoded to be rendered in response to a selection, a hover event, a click event, or other interaction with the content data. As an example, where the second portion of the content data corresponds to one or more identified keywords, the second portion of the content data (e.g., the one or more identified keywords encoded in the secondary language) may be rendered in response to a user interaction with the one or more identified keywords in the content data as encoded in the primary language.

The method of FIG. 7 may further comprise sending 708 (e.g., by the server 104), to a user device 102, the first portion of the content data and the second portion of the content data. For example, the server 104 may send the content data (e.g., comprising the first portion of the content data and the second portion of the content data) as a web page or other content. The content data may comprise, for example, a web page comprising the text data of the source content data translated into the primary language (e.g., the first portion of the content data) and one or more keywords encoded and/or translated to the second language (e.g., the second portion of the content data). The content data may also comprise search results responsive to a search query, with a first portion of the search results being based on the primary language (e.g., the first portion of the content data) and a second portion of the search results based on the secondary language (e.g., the second portion of the content data).

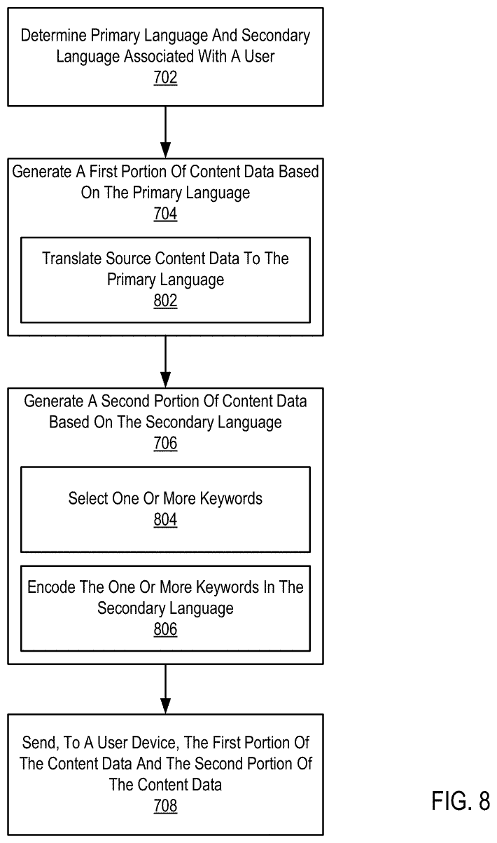

For further explanation, FIG. 8 sets forth a flow chart illustrating an exemplary method for secondary language support according to embodiments of the present invention that includes determining 702 a primary language and a secondary language associated with a user; generating 704 a first portion of content data based on the primary language; generating 706 a second portion of the content data based on the secondary language; and sending 708, to a user device, the first portion of the content data and the second portion of the content data.

FIG. 8 differs from FIG. 7 in that generating the first portion of content data based on the primary language comprises translating 802 source content data to the primary language. A translation algorithm may be applied to a web page or other source content data to translate the text of the source content data into the primary language. For example, assuming a primary language setting of English, the text of a web page encoded in Spanish may be translated into English. Accordingly, generating the first portion of the content data may comprise replacing portions of the source content data (e.g., the untranslated text) with corresponding portions translated into the primary language.

FIG. 8 further differs from FIG. 7 in that the generating the second portion of the content data based on the secondary language comprises selecting 804 one or more keywords (e.g., of text in the source content data). For example, selecting the one or more keywords may comprise selecting one or more identified keywords. The one or more keywords may be selected based on a tag, identifier, or other encoding in the source content data (e.g., a markup language tag). The one or more keywords may also be selected based on a template element that includes the one or more keywords. For example, the one or more keywords may be selected as keywords included in a header or menu.

Selecting the one or more keywords may also comprise selecting the one or more keywords based on a translation exception. The translation exception may be associated with the translation of the source content data to the primary language. A translation exception may include a particular keyword not being included in a dictionary or other listing of words in the primary language. The translation algorithm may programmatically or dynamically translate the particular keyword for inclusion in the first portion of the content data (e.g., using natural language processing). Such a keyword may be considered a potentially incorrect translation as no exact listing for the keyword may be found.

FIG. 8 further differs from FIG. 7 in that the generating the second portion of the content data based on the secondary language further comprises encoding 806, as the second portion of the content data, in the secondary language. Encoding the selected one or more keywords in the secondary language may comprise translating the one or more keywords into the secondary language. The source content data may be encoded in the secondary language. Accordingly, generating the second portion of the content data may comprise encoding the one or more keywords in the content data untranslated (e.g., in the secondary language).

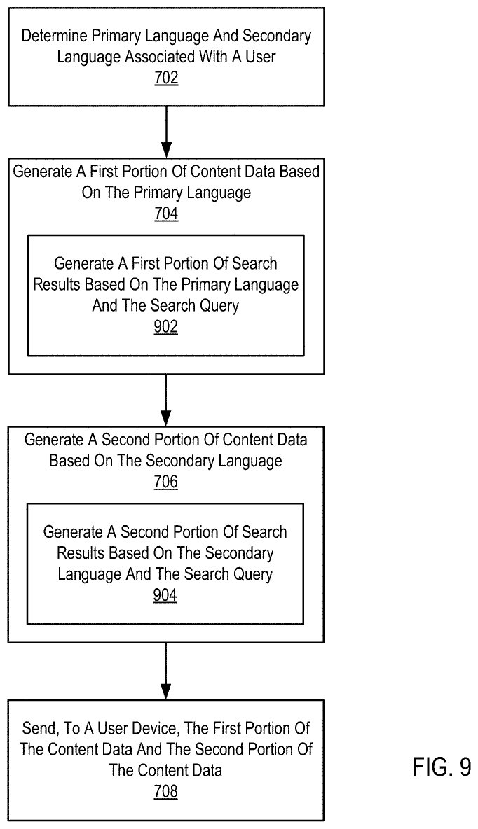

For further explanation, FIG. 9 sets forth a flow chart illustrating an exemplary method for secondary language support according to embodiments of the present invention that includes determining 702 a primary language and a secondary language associated with a user; generating 704 a first portion of content data based on the primary language; generating 706 a second portion of the content data based on the secondary language; and sending 708, to a user device, the first portion of the content data and the second portion of the content data.

FIG. 9 differs from FIG. 7 in that generating the first portion of the content data based on the primary language comprises generating 902 a first portion of search results based on the primary language and a search query. For example, a search engine may limit a scope of search to data (e.g., web sites) written in or encoded in a particular language. Accordingly, generating the first portion of the content data based on the primary language may comprise generating the first portion of search results responsive to the search query based on a scope defined by the primary language. As another example, a search engine may perform natural language processing on the search query or searchable data based on the primary language.

FIG. 9 further differs from FIG. 7 in that generating the second portion of the content data based on the second language comprises generating 904 a second portion of search results based on the secondary language and the search query. Thus, the content data comprises a first portion of search results based on the primary language and a second portion of search results based on the secondary language.

In view of the explanations set forth above, readers will recognize that the benefits of secondary language support according to embodiments of the present invention include:
Increased usability for content translations and users who are proficient in multiple languages.
Increased scope of search results by searching across multiple language scopes and presenting combined results.

Exemplary embodiments of the present invention are described largely in the context of a fully functional computer system for secondary language support. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of secondary language support, the method comprising:
determining a primary language and a secondary language associated with a user;
generating a first portion of content data based on the primary language;
generating a second portion of the content data based on the secondary language; and
sending, to a user device associated with the user, the first portion of the content data and the second portion of the content data.

2. The method of claim 1, wherein generating the first portion of the content data comprises translating source content data to the primary language, and wherein generating the second portion of the content data comprises:
selecting one or more keywords; and
encoding, as the second portion of the content data, the one or more keywords in the secondary language.

3. The method of claim 2, wherein selecting the one or more keywords comprises selecting one or more identified keywords.

4. The method of claim 2, wherein selecting the one or more keywords comprises selecting the one or more keywords based on a translation exception.

5. The method of claim 1, wherein generating the second portion of the content data based on the secondary language comprises:
sending the second portion of the content data as a hidden portion of the content data; and
wherein the hidden portion of the content data is configured to be rendered in response to a user interaction with the content data.

6. The method of claim 5, wherein the user interaction comprises one or more of a selection or a hover event applied to a portion of the content data encoded in the primary language and corresponding to the hidden portion of the content data.

7. The method of claim 1:
wherein generating the first portion of the content data comprises generating a first portion of search results based on the primary language and a search query; and
wherein generating the second portion of the content data comprises generating a second portion of the search results based on the secondary language and the search query.

8. An apparatus for secondary language support, the apparatus comprising a computer processor, a computer memory operatively coupled to the computer processor, the computer memory having disposed within it computer program instructions that, when executed by the computer processor, cause the apparatus to carry out the steps of:
determining a primary language and a secondary language associated with a user;
generating a first portion of content data based on the primary language;
generating a second portion of the content data based on the secondary language; and
sending, to a user device associated with the user, the first portion of the content data and the second portion of the content data.

9. The apparatus of claim 8, wherein generating the first portion of the content data comprises translating source content data to the primary language, and wherein generating the second portion of the content data comprises:
selecting one or more keywords; and
encoding, as the second portion of the content data, the one or more keywords in the secondary language.

10. The apparatus of claim 9, wherein selecting the one or more keywords comprises selecting one or more identified keywords.

11. The apparatus of claim 9, wherein selecting the one or more keywords comprises selecting the one or more keywords based on a translation exception.

12. The apparatus of claim 11, wherein generating the second portion of the content data based on the secondary language comprises:
sending the second portion of the content data as a hidden portion of the content data; and
wherein the hidden portion of the content data is configured to be rendered in response to a user interaction with the content data.

13. The apparatus of claim 12, wherein the user interaction comprises one or more of a selection or a hover event applied to a portion of the content data encoded in the primary language and corresponding to the hidden portion of the content data.

14. The apparatus of claim 8:
wherein generating the first portion of the content data comprises generating a first portion of search results based on the primary language and a search query; and
wherein generating the second portion of the content data comprises generating a second portion of the search results based on the secondary language and the search query.

15. A computer program product for secondary language support, the computer program product disposed upon a computer readable medium, the computer program product comprising computer program instructions that, when executed, cause a computer to carry out the steps of:
determining a primary language and a secondary language associated with a user;
generating a first portion of content data based on the primary language;
generating a second portion of the content data based on the secondary language; and
sending, to a user device associated with the user, the first portion of the content data and the second portion of the content data.

16. The computer program product of claim 15, wherein generating the first portion of the content data comprises translating source content data to the primary language, and wherein generating the second portion of the content data comprises:
selecting one or more keywords; and
encoding, as the second portion of the content data, the one or more keywords in the secondary language.

17. The computer program product of claim 16, wherein selecting the one or more keywords comprises selecting one or more identified keywords.

18. The computer program product of claim 15, wherein generating the second portion of the content data based on the secondary language comprises:
sending the second portion of the content data as a hidden portion of the content data; and
wherein the hidden portion of the content data is configured to be rendered in response to a user interaction with the content data.

19. The computer program product of claim 18, wherein the user interaction comprises one or more of a selection or a hover event applied to a portion of the content data encoded in the primary language and corresponding to the hidden portion of the content data.

20. The computer program product of claim 15:
wherein generating the first portion of the content data comprises generating a first portion of search results based on the primary language and a search query; and
wherein generating the second portion of the content data comprises generating a second portion of the search results based on the secondary language and the search query.
